(19) United States
(12) Patent Application Publication
(10) Pub. No.: US 2008/0144097 A1
(43) Pub. Date: Jun. 19, 2008

(54) IMAGE PROCESSING APPARATUS AND IMAGE PROCESSING METHOD

(76) Inventor: Tomoki YOSHIDA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/958,078

(22) Filed: Dec. 17, 2007

(30) Foreign Application Priority Data
Dec. 18, 2006 (JP) 2006-339910

(51) Int. Cl. G06F 15/00

(52) U.S. Cl. 358/1.15

(57) ABSTRACT

An image processing apparatus is disclosed. The image processing apparatus includes plural image outputting filters disposed corresponding to plural image outputting devices, a preview image filter which forms a preview image of an image to be output from each of the plural image outputting filters, a setting interface section which interfaces settings for outputting the preview image to be output from the preview image filter with settings for outputting the image to be output from each of the plural image outputting filters, and a processing order control section which controls executing processes in the image outputting filter corresponding to the preview image in the plural image outputting filters after receiving a report of completion of outputting the preview image from the preview image filter. An additional image outputting filter can be installed in the image processing apparatus and an existing image outputting filter can be uninstalled from the image processing apparatus.

### BACKGROUND OF THE INVENTION

1. Field of the Invention

The present invention generally relates to an image processing apparatus and an image processing method in which a preview image outputting function for an image to be output can be easily installed in or uninstalled from the image processing apparatus.

2. Description of the Related Art

Conventionally, in an image processing apparatus which outputs an image by controlling plural devices, in order to make the development efficiency of the image processing apparatus high, each of devices in a control section of the image processing apparatus has been developed with high independence.

For example, in Patent Document 1, an image forming apparatus is disclosed. In the image forming apparatus, a service layer, which is used in common with application layers, is formed of modules having corresponding functions. When a module in an application layer is changed, changes of a module of the service layer and a module of another application layer can be minimal.

[Patent Document 1] Japanese Patent No. 3679349 (Japanese Laid-Open Patent Application No. 2002-084383)

However, in Patent Document 1, when an existing function in the image forming apparatus is changed, the service layer does not need to have a module changed; however, when a new function is installed in the image forming apparatus, a module in the service layer must be changed. That is, the development efficiency of the image forming apparatus is not high.

In addition, when a so-called preview image function for displaying a preview image of an image to be output from the image forming apparatus beforehand on an operating panel of the image forming apparatus is installed in the image forming apparatus, in addition to changing a module in the service layer, a module in the application layer corresponding to a preview image output must be changed. Consequently, labor hours for changing the module in the application layer must be further consumed.

### SUMMARY OF THE INVENTION

In a preferred embodiment of the present invention, there is provided an image processing apparatus and an image processing method in which a preview image outputting function can be easily installed in or uninstalled from the image processing apparatus.

Features and advantages of the present invention are set forth in the description that follows, and in part will become apparent from the description and the accompanying drawings, or may be learned by practice of the invention according to the teachings provided in the description. Features and advantages of the present invention may be realized and attained by an image processing apparatus and an image processing method particularly pointed out in the specification in such full, clear, concise, and exact terms so as to enable a person having ordinary skill in the art to practice the invention.

To achieve one or more of these and other advantages, according to one aspect of the present invention, there is provided an image processing apparatus. The image processing apparatus includes plural image outputting filters disposed corresponding to plural image outputting devices, a preview image filter which forms a preview image of an image to be output from each of the plural image outputting filters, and a setting interface section which interfaces settings for outputting the preview image to be output from the preview image filter with settings for outputting the image to be output from each of the plural image outputting filters. In addition, one or more additional image outputting filters can be installed in the image processing apparatus and one or more existing image outputting filters can be uninstalled from the image processing apparatus.

According to another aspect of the present invention, there is provided an image processing method in an image processing apparatus. The image processing method includes the steps of disposing a plurality of image outputting filters corresponding to a plurality of image outputting devices, forming a preview image of an image to be output from each of the plural image outputting filters by a preview image filter, and interfacing settings for outputting the preview image to be output from the preview image filter with settings for outputting the image to be output from each of the plural image outputting filters by a setting interface section. In addition, one or more additional image outputting filters can be installed in the image processing apparatus and one or more existing image outputting filters can be uninstalled from the image processing apparatus.

### EFFECT OF THE INVENTION

According to an embodiment of the present invention, in addition to installing a preview image filter in an image processing apparatus, the image processing apparatus can install one or more additional image outputting filters in the image processing apparatus and can uninstall one or more existing image outputting filters from the image processing apparatus. Therefore, a preview image outputting function can be easily realized.

### BRIEF DESCRIPTION OF THE DRAWINGS

Features and advantages of the present invention will become more apparent from the following detailed description when read in conjunction with the accompanying drawings, in which:

FIG. 1 is a diagram showing a functional structure of an image processing apparatus according to an embodiment of the present invention;

FIG. 2 is a diagram showing a concept of pipes-and-filters architecture which is applied to the embodiment of the present invention;

FIG. 3 is a diagram showing a structure for displaying a preview image of an image to be printed according to the embodiment of the present invention;

FIG. 4 is a diagram showing generation of a printing job and a preview image displaying job in the pipes-and-filters architecture according to the embodiment of the present invention;

FIG. 5 is a diagram showing a first flow of information for setting the image printing input from a printing UI when an image printing filter has information that a preview image is to be displayed according to the embodiment of the present invention;

FIG. 6 is a diagram showing a flow of the information for setting the image printing in the functional structure shown in FIG. 1;

FIG. 7 is a flowchart showing processes in the image printing filter, a setting interface section, and a preview image filter based on the information for setting the image printing;

FIG. 8 is a diagram showing a second flow of the information for setting the image printing input from a printing UI when the image printing filter does not have information that a preview image is to be displayed;

FIG. 9 is a diagram showing a flow of information for setting the image printing input from a local UI section to the image printing filter and the preview image filter;

FIG. 10 is a diagram showing a flow of the information for setting the image printing when the information is input from a preview image UI to the preview image filter;

FIG. 11 is a diagram showing preview images displayed on an operating section device based on information from the preview image UI shown in FIG. 10;

FIG. 12 is a diagram showing operations for controlling the processing order of filters by a processing order control section shown in FIG. 1;

FIG. 13 is a diagram showing processes of displaying a preview image based on control of the processing order of filters;

FIG. 14 is a diagram showing operations where the processing order control section makes the image printing filter print an image on a recording medium based on the completion of displaying the preview image;

FIG. 15 is a flowchart showing processes in the processing order control section and the preview image filter based on control of the processing order of processes in filters;

FIG. 16 is a diagram showing processes of printing an image based on control of the processing order of filters;

FIG. 17 is a flowchart showing processes in the processing order control section and the image printing filter based on control of the processing order of processes in filters;

FIG. 18 is a diagram showing a modified example of the image processing apparatus according the embodiment of the present invention; and

FIG. 19 is a diagram showing a structure of a computer by which the functions of the image processing apparatus of the present embodiment are realized.

### DESCRIPTION OF THE PREFERRED EMBODIMENT

### Best Mode of Carrying Out the Invention

The best mode of carrying out the present invention is described with reference to the accompanying drawings.

In the embodiment of the present invention, as an image processing apparatus, an MFP (multifunctional peripheral) is used. However, the image processing apparatus is not limited to the MFP, and can be an image processing apparatus having a preview image outputting function or another image processing apparatus which can have the preview image outputting function installed in the image processing apparatus or can have the function uninstalled from the image processing apparatus.

[Functional Structure of Image Processing Apparatus]

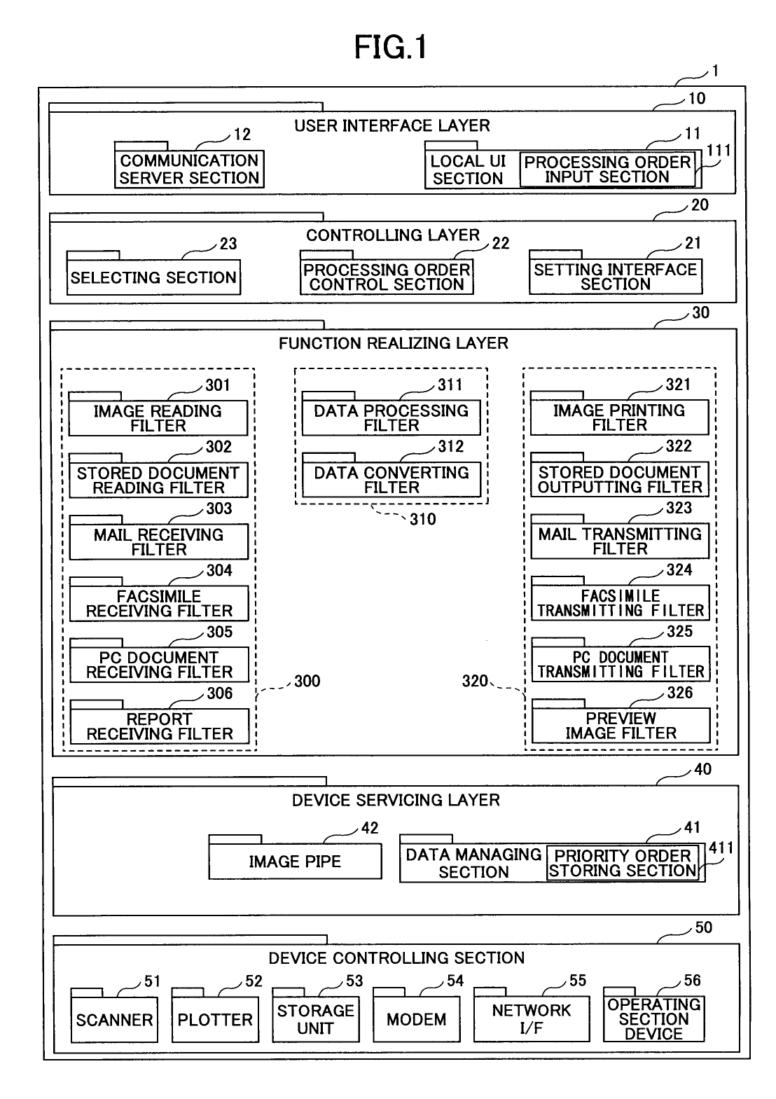

FIG. 1 is a diagram showing a functional structure of an MFP 1 according to the embodiment of the present invention. The MFP 1 is an image processing apparatus in which plural functions such as a printer function, a scanner function, and a facsimile function are installed in one cabinet.

As shown in FIG. 1, the MFP 1 includes a user interface layer 10, a controlling layer 20, a function realizing layer 30, and a device servicing layer 40 as software, and a device controlling section 50 as hardware. In FIG. 1, in the relationships among the layers, basically, an upper layer calls up a lower layer.

The user interface layer 10 receives a request for executing a job, for example, copying a document, printing a document, scanning a document, and transmitting a document by facsimile. The user interface layer 10 includes a local UI (user interface) section 11 and a communication server section 12.

The local UI section 11 receives a request from a user input via, for example, an operating section device 56 in the device controlling section 50. The local UI section 11 can include a processing order input section 111 to which a processing order of filters (described below) is input. A user can input the processing order of the filters in the function realizing layer 30 by using the processing order input section 111.

The communication server section 12 receives a request from, for example, a client PC (personal computer) (not shown) via a network. The request received by the user interface layer 10 is sent to the controlling layer 20.

The controlling layer 20 controls processes for executing a requested job. The controlling layer 20 includes a setting interface section 21, a processing order control section 22, and a selecting section 23. The setting interface section 21 interfaces information of settings between the filters. The processing order control section 22 controls the processing order of the filters. The selecting section 23 selects a filter for executing the requested job.

The function realizing layer 30 includes software components each of which executes a part of a job in the MFP 1. That is, by combining the software components, a job is performed. In the embodiment of the present invention, when a job in the MFP 1 is executed by software, software architecture called “pipes-and-filters architecture” is used. Therefore, each software component is called a filter.

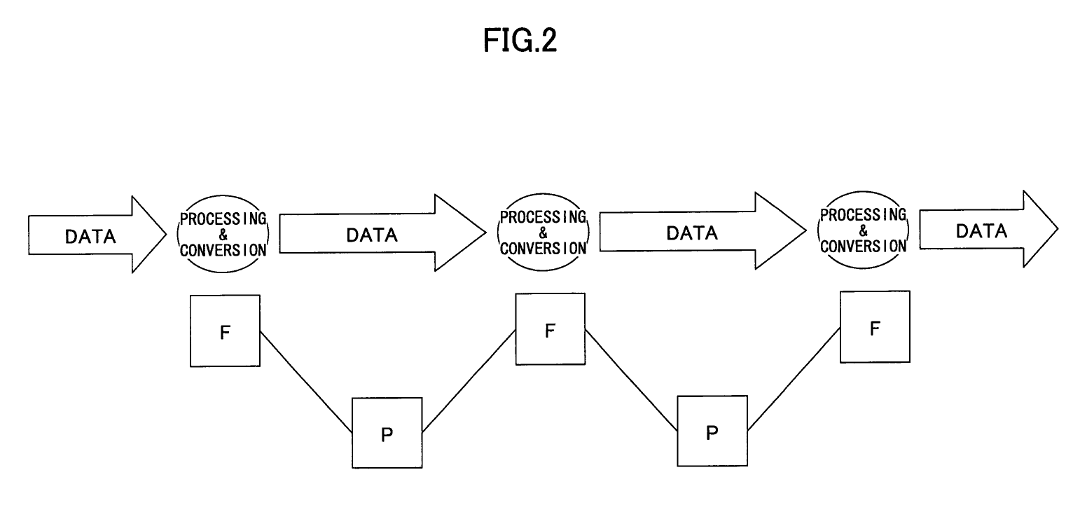

FIG. 2 is a diagram showing a concept of the pipes-and-filters architecture. In FIG. 2, “F” shows a filter and “P” shows a pipe. As shown in FIG. 2, a filter is connected to another filter via a pipe. A first filter applies conversion (processing) to input data and outputs the converted data to a second filter. A first pipe sends the data converted by the first filter to the second filter. The above operations are sequentially executed from the first filter to the end filter.

In the MFP 1 in the embodiment of the present invention, a function is regarded as “conversion” of data of a document and the conversion is continuously executed corresponding to the functions. A job in the MFP 1 can be generalized as a sequence of an input of data of a document, a process for the data, and an output of the processed data. Therefore, “input”, “process”, and “output” are regarded as corresponding conversions. A software component for realizing one conversion is a filter. Each filter is independent among the filters, and basically there is not a dependence relationship among the filters. Therefore, a filter can be installed in or uninstalled from the MFP 1.

Returning to FIG. 1, the function realizing layer 30 includes an image inputting filter 300, an image processing filter 310, and an image outputting filter 320. The image inputting filter 300 realizes inputting image data and includes an image reading filter 301, a stored document reading filter 302, a mail receiving filter 303, a facsimile receiving filter 304, a PC document receiving filter 305, and a report receiving filter 306.

The image reading filter 301 makes a scanner 51 read image data and makes the scanner 51 output the read image data. The stored data reading filter 302 reads image data (document data) stored in a storage unit 53 of the MFP 1 and outputs the read image data. The mail receiving filter 303 receives e-mail and outputs data included in the e-mail. The facsimile receiving filter 304 controls a facsimile machine (not shown) so that the facsimile machine receives a facsimile and outputs data of the received facsimile. The PC document receiving filter 305 receives image data transmitted from a PC (personal computer) (not shown) or another image processing apparatus (not shown) via a network I/F 55 and outputs the received image data. The report receiving filter 306 receives information, for example, setting information of the MFP 1 and image data input history information in the MFP 1 from the storage unit 53, and outputs the received information as data in a table format.

The image processing filter 310 realizes processing image data and includes a data processing filter 311 and a data converting filter 312. The data processing filter 311 applies an image process (for example, a plural-image aggregating process, an image enlarging process, and an image reducing process) to input document data, and outputs the processed document data. The data converting filter 312 converts a data format of image data into another data format. The data converting filter 312 applies, for example, a rendering process to the input image data. For example, the data converting filter 312 converts input PostScript data into bitmap data and outputs the converted data.

The image processing filter 310 includes image processing filter 310a and 310b based on corresponding processes in the MFP 1 (described below).

The image outputting filter 320 realizes outputting an image and includes an image printing filter 321, a stored document outputting filter 322, a mail transmitting filter 323, a facsimile transmitting filter 324, a PC document transmitting filter 325, and a preview image filter 326.

The image printing filter 321 makes a plotter 52 output (print) processed image data on a recording medium. The stored document outputting filter 322 outputs processed image data (document data), for example, on the operating section device 56. The mail transmitting filter 323 transmits processed image data by attaching the data to e-mail. The facsimile transmitting filter 324 makes the facsimile machine transmit processed image data by facsimile. The PC document transmitting filter 325 transmits the processed image data to a PC (not shown) or another image processing apparatus (not shown) via the network I/F 55. The preview image filter 326 makes the operating section device 56 display a preview image of an image to be output via the local UI section 11.

The device servicing layer 40 is commonly used by the filters in the function realizing layer 30 and includes a data managing section 41 and an image pipe 42.

The data managing section 41 includes databases, for example, a database where user information is stored and a database where document data and image data are stored. The data managing section 41 can further include a priority order storing section 411 where a priority order for processing processes in the filters is stored.

The image pipe 42 transfers image data from a filter to another filter.

The device controlling section 50 includes devices such as the scanner 51, the plotter 52, the storage unit 53, a modem 54, the network I/F 55, and the operating section device 56. The device controlling section 50 further includes a device controlling unit (not shown) for controlling the above devices.

The scanner 51 optically reads an image. The plotter 52 forms (prints) an image on a recording medium. The storage unit 53 stores, for example, image data which are processed by the function realizing layer 30 and computer programs with which the functions of the MFP 1 are realized. The modem 54 is used when the MFP 1 is connected to a computer or an image processing apparatus having a computer function via a public telephone line. The network I/F 55 is used when the MFP 1 is connected to a computer or an image processing apparatus having a computer function via a network.

The operating section device 56 includes a displaying device and an inputting device, displays operating conditions of the MFP 1, and receives an instruction from a user to the MFP 1. The operating section device 56 is, for example, an operating panel.

[Displaying Processes of Preview Image of Image to be Printed (Copied) on Recording Medium]

Next, referring to the drawings, as an example, displaying processes of a preview image of an image to be printed (copied) on a recording medium are described. In the MFP 1, the preview image is not limited to the preview image of the image to be printed, and the displaying processes of the preview image can be applied to a preview image of another image to be output from the MFP 1. The preview image of the image to be output is, for example, a preview image of an image to be output from the stored document outputting filter 322, a preview image of an image to be output from the mail transmitting filter 323, a preview image of an image to be output from the facsimile transmitting filter 324, and a preview image of an image to be output from the PC document transmitting filter 325.

In addition, as described above, the image inputting filter 300 includes the plural filters 301 through 306 and the image outputting filter 320 includes the plural filters 321 through 326. When a user desires to execute an additional job and desires to display a preview image of the additional job, the user can install an additional image inputting filter (if necessary) and an additional image outputting filter. Further, when the user desires not to execute an existing job, the user can uninstall an existing image inputting filter (if necessary) and an existing image outputting filter except for the preview image filter 326.

[Structure for Displaying Preview Image]

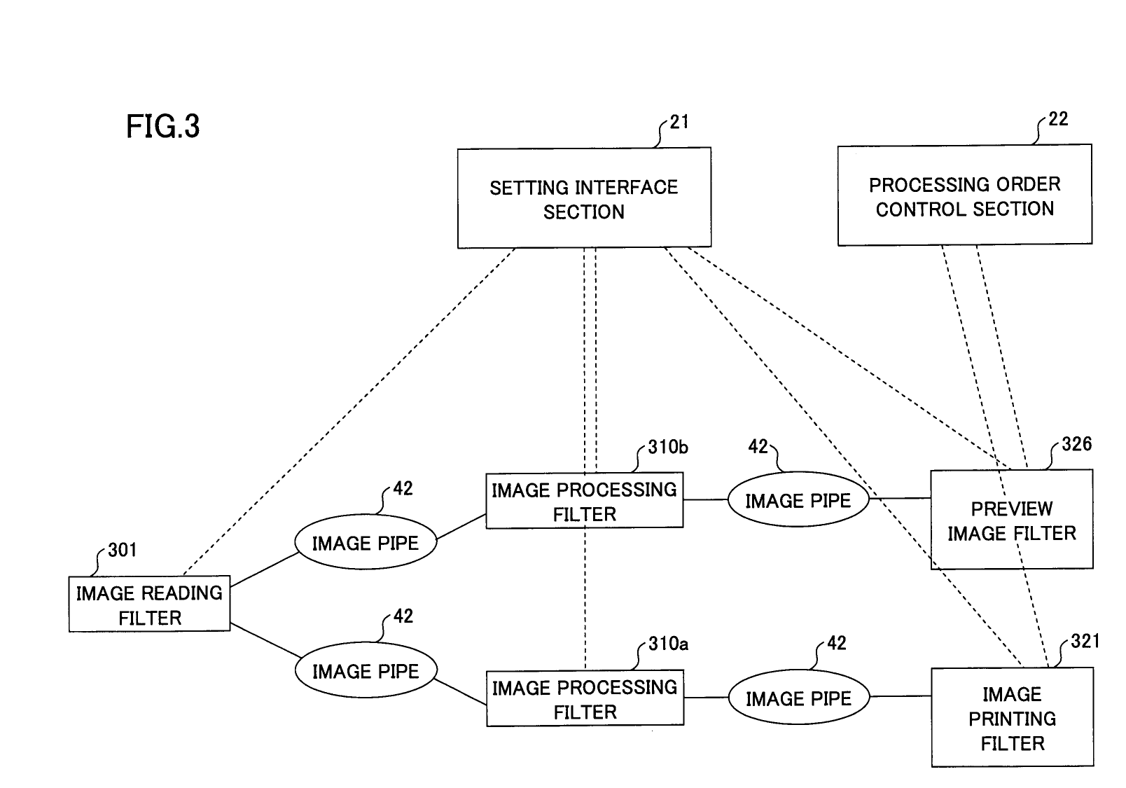

FIG. 3 is a diagram showing a structure for displaying a preview image of an image to be printed. In the structure shown in FIG. 3, filters are connected via the corresponding image pipes 42 for displaying a preview image of an image to be printed based on a printing job of the MFP 1.

As shown in FIG. 3, the image reading filter 301 is connected to the image processing filter 310a via the image pipe 42 and further the image processing filter 310a is connected to the image printing filter 321 via the image pipe 42. Further, the image reading filter 301 is connected to the image processing filter 310b via the image pipe 42 and further the image processing filter 310b is connected to the preview image filter 326 via the image pipe 42. With this, the preview image displaying function is realized.

In addition, settings for processing image data in the image processing filters 310a and 310b are interfaced with settings for outputting a preview image in the preview image filter 326 and settings for outputting an image in the image printing filter 321 by the setting interface section 21 of the controlling layer 20. With this, a preview image to be formed by the preview image filter 326 corresponds to an image to be output from the image printing filter 321. Further, settings in the image reading filter 301 are interfaced with the settings in the image processing filters 310a and 310b and the settings in the preview image filter 326 and the image printing filter 321 by the setting interface section 21.

In addition, the processing order control section 22 of the controlling layer 20 controls the processing order of the processes in the preview image filter 326 and the image printing filter 321. With this, the image printing filter 321 can execute the image printing processes based on the settings for outputting a preview image in the preview image filter 326. The preview image is displayed on the operating section device 56 (described below).

[Generation of Printing Job and Preview Image Displaying Job]

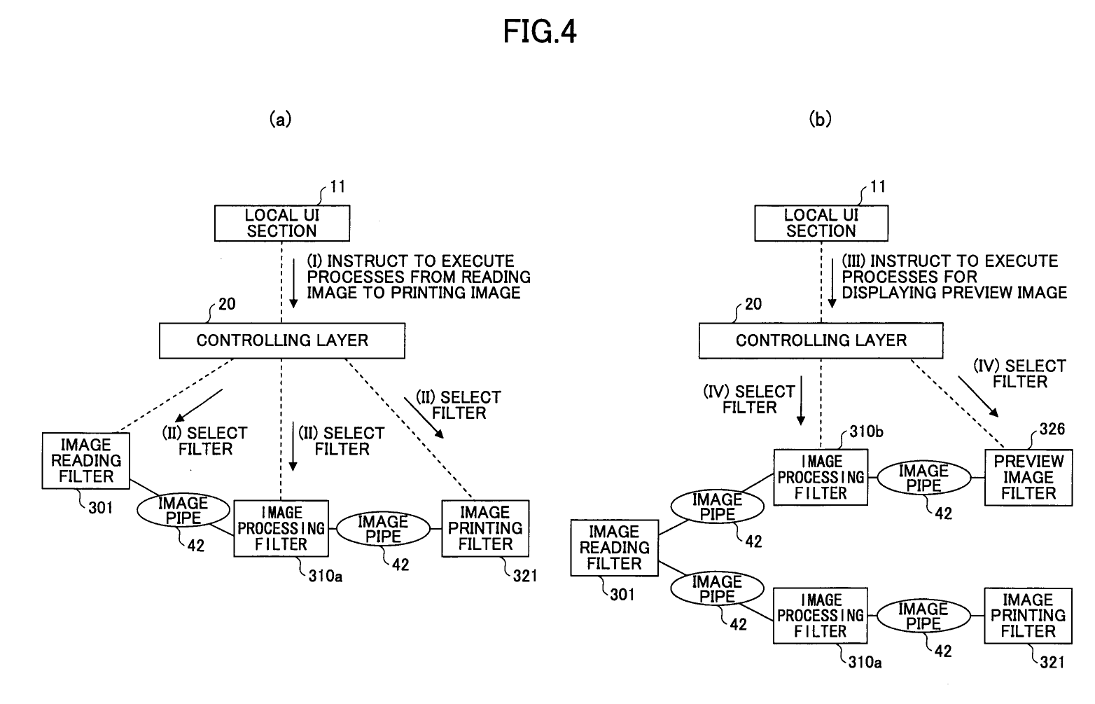

FIG. 4 is a diagram showing generation of a printing job and a preview image displaying job in the pipes-and-filters architecture. In FIG. 4(a), the printing job is generated. In FIG. 4(a), the local UI section 11 instructs the controlling layer 20 to execute processes from reading an image to printing the image. The controlling layer 20, based on the instruction from the local UI section 11, selects the image reading filter 301, the image processing filter 310a, and the image printing filter 321 from the filters in the function realizing layer 30, and connects the selected filters with the corresponding image pipes 42. With this, the processes from the image reading to the image printing via the plotter 52 can be executed.

In FIG. 4(b), in addition to generating the printing job shown in FIG. 4(a), a preview image displaying job is generated. In FIG. 4(b), the local UI section 11 instructs the controlling layer 20 to execute processes for displaying a preview image of an image to be printed. The controlling layer 20, based on the instruction from the local UI section 11, selects the image processing filter 310b and the preview image filter 326 from the filters in the function realizing layer 30, and connects the selected filters with the corresponding image pipes 42. With this, the processes from reading the image to displaying the preview image can be executed via the operating section device 56.

In FIG. 4, the controlling layer 20 directly selects the image reading filter 301, the image processing filters 310a and 310b, the image printing filter 321, and the preview image filter 326. However, the selecting section 23 of the controlling layer 20 can select the filters.

[First Flow of Information for Setting Image Printing]

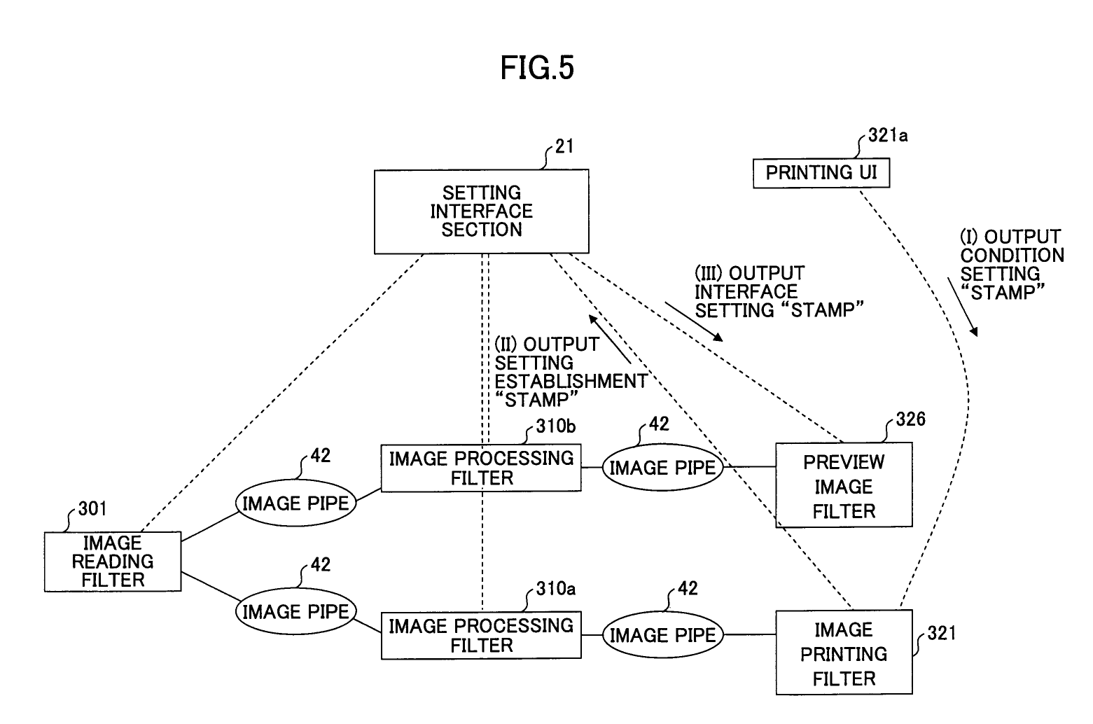

Information for setting image printing is input from a printing UI (user interface) 321a. The printing UI 321a can be included in the local UI section 11. FIG. 5 is a diagram showing a first flow of the information for setting the image printing input from the printing UI 321a when the image printing filter 321 has information whether a preview image is to be displayed.

In FIG. 5, first, condition setting “STAMP” is input to the image printing filter 321 from the printing UI 321a (I). The condition setting “STAMP” is information for setting the image printing. When the image printing filter 321 has information that a preview image is to be displayed, the image printing filter 321 outputs setting establishment “STAMP” to the setting interface section 21 (II).

The setting interface section 21 outputs interface setting “STAMP” to the preview image filter 326 based on the setting establishment “STAMP” (III).

By the above, the image printing filter 321 and the preview image filter 326 obtain the information for setting the image printing.

That is, a user can input the information whether a preview image of an image to be printed is displayed from the local UI section 11 via the operating section device 56. However, even without the information that a preview image of an image to be printed is displayed, the preview image can be displayed (described below).

[Flow of Information for Setting Image Printing in Functional Structure shown in FIG. 1]

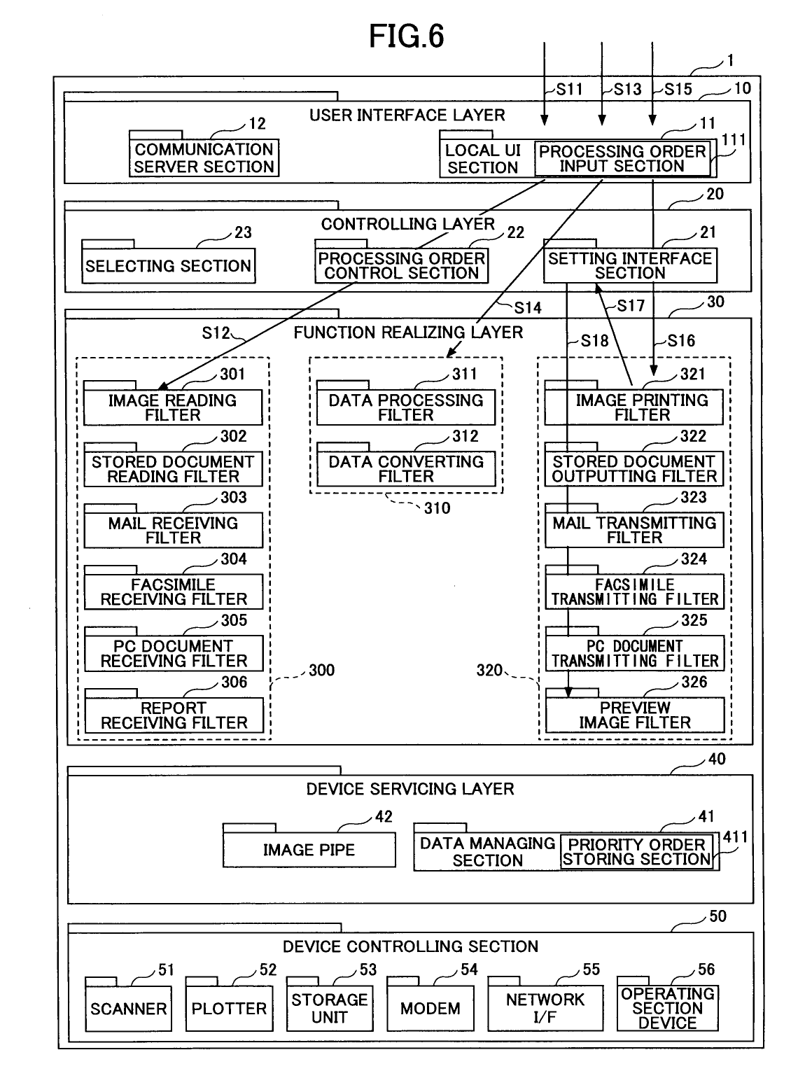

FIG. 6 is a diagram showing a flow of the information for setting the image printing in the functional structure shown in FIG. 1.

In FIG. 6, first, a user of the MFP 1 inputs information for setting image reading to the local UI section 11 via the operating section device 56 (S11). The local UI section 11 outputs the information for setting the image reading to the image reading filter 301 (S12). The image reading filter 301 establishes settings for the image reading.

In the settings for the image reading, for example, resolution, color, and a gray scale of color coordinates at reading an image are set.

In addition, the user of the MFP 1 inputs information for setting image processing to the local UI section 11 via the operating section device 56 (S13). The local UI section 11 outputs the information for setting the image processing to the image processing filter 310 (S14). The image processing filter 310 establishes settings for the image processing.

In the settings for the image processing, for example, enlarging or reducing an image, adjusting the density of the image, and aggregation of documents are set.

In addition, the user of the MFP 1 inputs information for setting image printing to the local UI section 11 via the operating section device 56 (S15). The local UI section 11 outputs the information for setting the image printing to the image printing filter 321 (S16). The image printing filter 321 establishes settings for the image printing.

The image printing filter 321 outputs the information for setting the image printing to the setting interface section 21 (S17). The setting interface section 21 outputs the information for setting the image printing to the preview image filter 326 (S18).

In the settings for the image printing, for example, resolution, color, and a gray scale of color coordinates at printing an image are set. Further, information for determining whether a preview image is to be displayed can be included in the settings for the image printing. In addition, information for stapling documents and for punching the documents can be included in the settings for the image printing.

[Processes in Filters based on Information for Setting Image Printing]

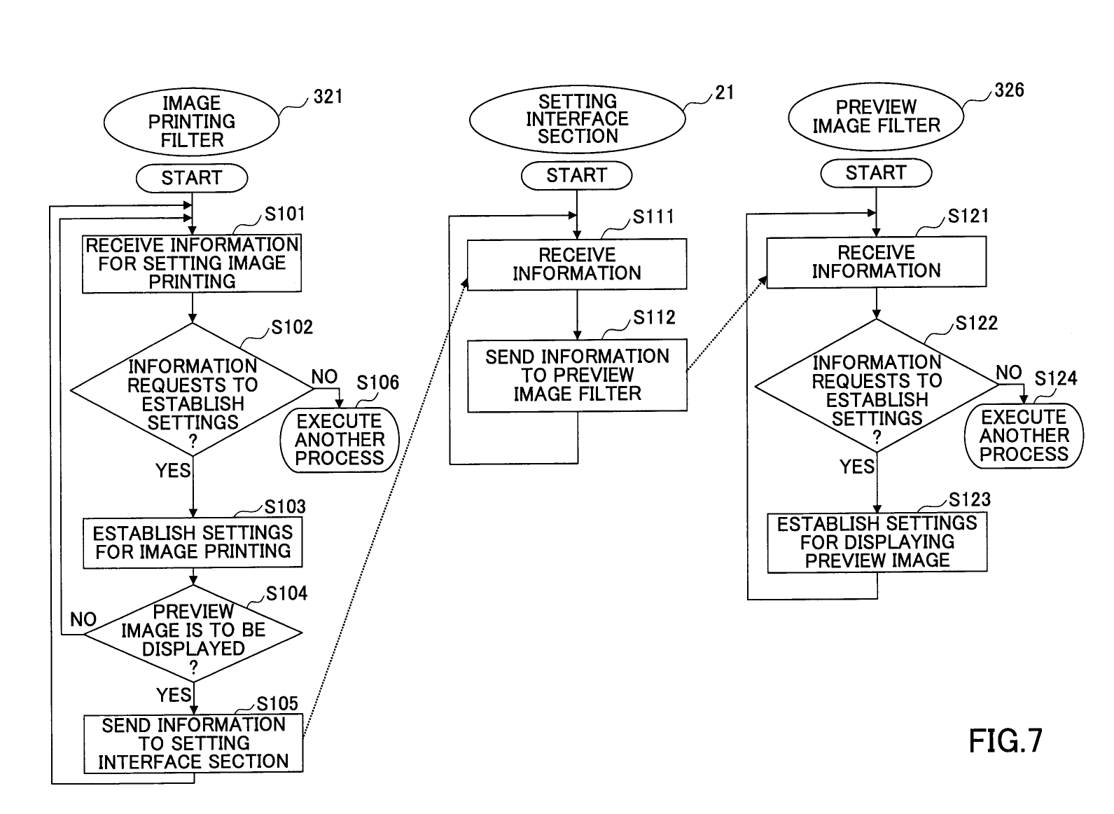

FIG. 7 is a flowchart showing processes in the image printing filter 321, the setting interface section 21, and the preview image filter 326 based on the information for setting the image printing. In FIG. 7, the information for setting the image printing, which is input to the image printing filter 321, is input to the preview image filter 326 via the setting interface section 21.

In FIG. 7, processes from S101 through SS106 are executed by the image printing filter 321. First, the image printing filter 321 receives information for setting image printing (S101). The information for setting the image printing is input from the printing UI 321a. The image printing filter 321 determines whether the information for setting the image printing requests to establish settings for the image printing (S102). When the information for setting the image printing requests to establish settings for the image printing (YES in S102), the image printing filter 321 establishes the settings for the image printing (S103). When the information for setting the image printing does not request to establish settings for the image printing (NO in S102), the image printing filter 321 executes another process (S106). The process in S106 is, for example, displaying an error report due to non-establishment of the settings.

The image printing filter 321 determines whether a preview image is to be displayed (S104). When a preview image is to be displayed (YES in S104), the image printing filter 321 sends the information for setting the image printing to the setting interface section 21 (S105).

When a preview image is not to be displayed (NO in S104), the process returns to S101.

Processes in S111 and S112 are executed by the setting interface section 21.

The setting interface section 21 receives the information from the image printing filter 321 (S111), and sends the information for setting the image printing to the preview image filter 326 (S112).

Processes from S121 through S124 are executed by the preview image filter 326.

The preview image filter 326 receives the information from the setting interface section 21 (S121). The preview image filter 326 determines whether the information requests to establish settings for displaying a preview image (S122). When the information requests to establish settings for displaying a preview image (YES in S122), the preview image filter 326 establishes the settings for displaying the preview image (S123).

When the information does not request to establish settings for displaying a preview image (NO in S122), the preview image filter 326 executes another process (S124). The process in S124, for example, the preview image filter 326 displays an error report due to non-establishment of the setting for displaying the preview image.

[Second Flow of Information for Setting Image Printing]

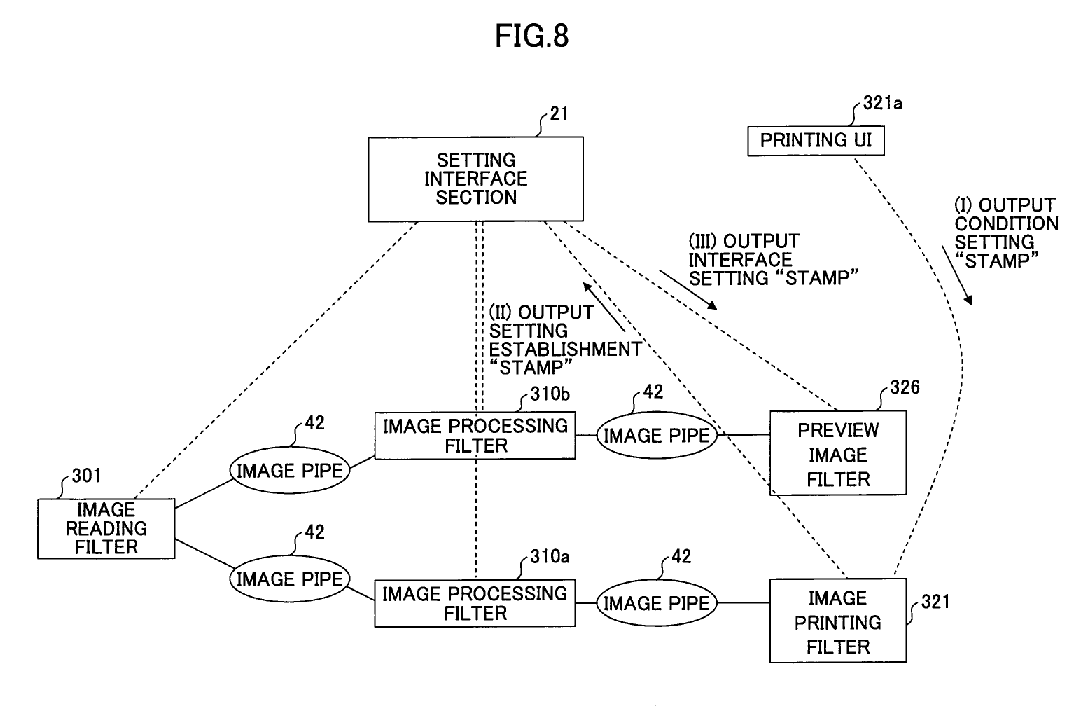

Information for setting image printing is input from the printing UI 321a. FIG. 8 is a diagram showing a second flow of the information for setting the image printing input from the printing UI 321a when the image printing filter 321 does not have information whether a preview image is to be displayed.

In the first flow shown in FIG. 5, the image printing filter 321 has the information whether a preview image is to be displayed. However, in the second flow shown in FIG. 8, the image printing filter 321 does not have the information whether a preview image is to be displayed. Therefore, in FIG. 8, every time when the printing UI 321a inputs the condition setting “STAMP” to the image printing filter 321 (I), the image printing filter 321 outputs the setting establishment “STAMP” to the setting interface section 21 (II). Then the setting interface section 21 outputs the interface setting “STAMP” to the preview image filter 326 (III).

Consequently, in the second flow shown in FIG. 8, the process shown in S104 of FIG. 7 is omitted.

[Flow of Information for Setting Image Printing from Local UI Section]

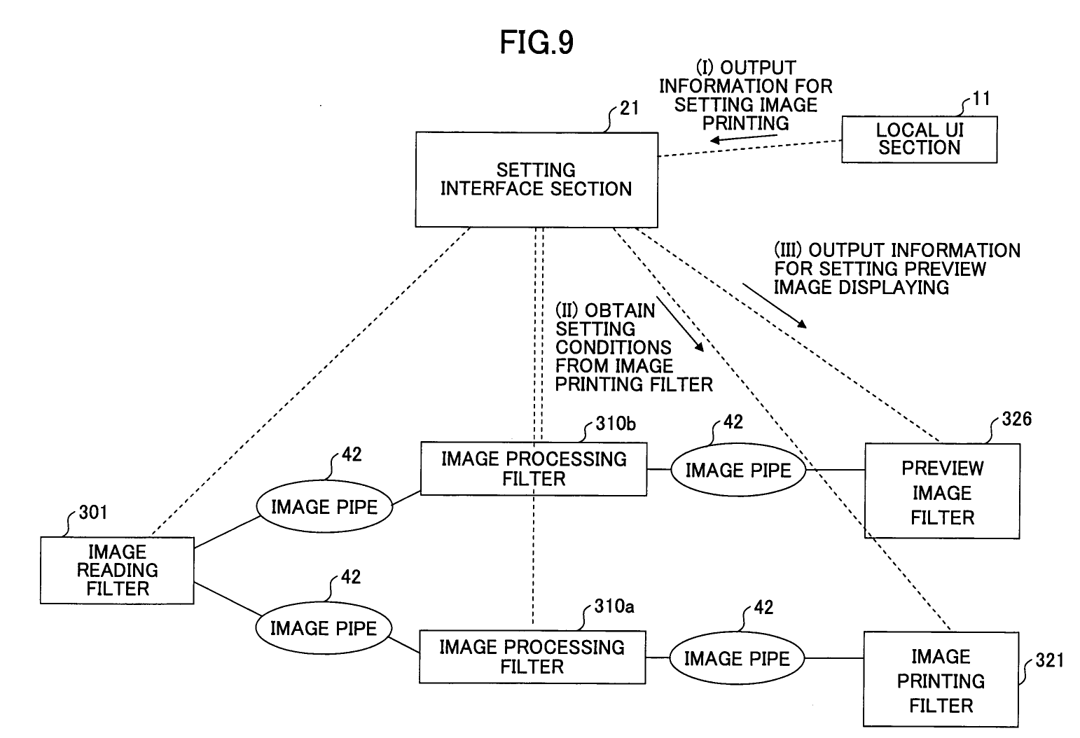

In this case, information for setting image printing is input from the local UI section 11. FIG. 9 is a diagram showing a flow of information for setting the image printing input from the local UI section 11 to the image printing filter 321 and the preview image filter 326.

In FIG. 9, first, the local UI section 11 outputs information for setting image printing to the setting interface section 21 (I). The setting interface section 21 obtains setting conditions for the image printing which conditions the image printing filter 321 has (II), and outputs information for setting preview image displaying based on the obtained setting conditions to the preview image filter 326 (III).

With this, the preview image filter 326 can display a preview image based on the setting conditions and the information for setting the image printing via the operating section device 56.

[Flow of Information for Setting Image Printing from Preview Image UI]

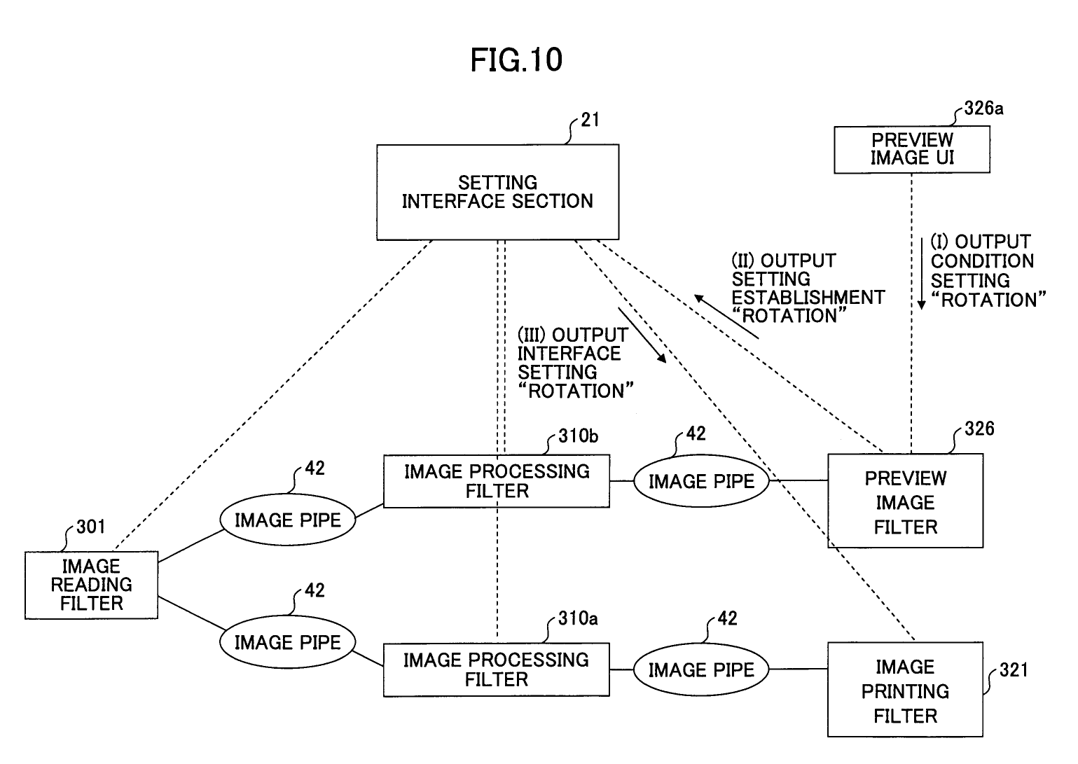

In this case, information for setting image printing is input from a preview image UI 326a. The preview image UI 326a can be included in the local UI section 11. FIG. 10 is a diagram showing a flow of the information for setting the image printing when the information is input from the preview image UI 326a to the preview image filter 326.

In FIG. 10, the preview image is displayed by rotating an original preview image. Therefore, the preview image UI 326a inputs condition setting “ROTATION” to the preview image filter 326 (I). The preview image filter 326 reports setting establishment “ROTATION” to the setting interface section 21 (II). The setting interface section 21 reports interface setting “ROTATION” to the image printing filter 321 (III).

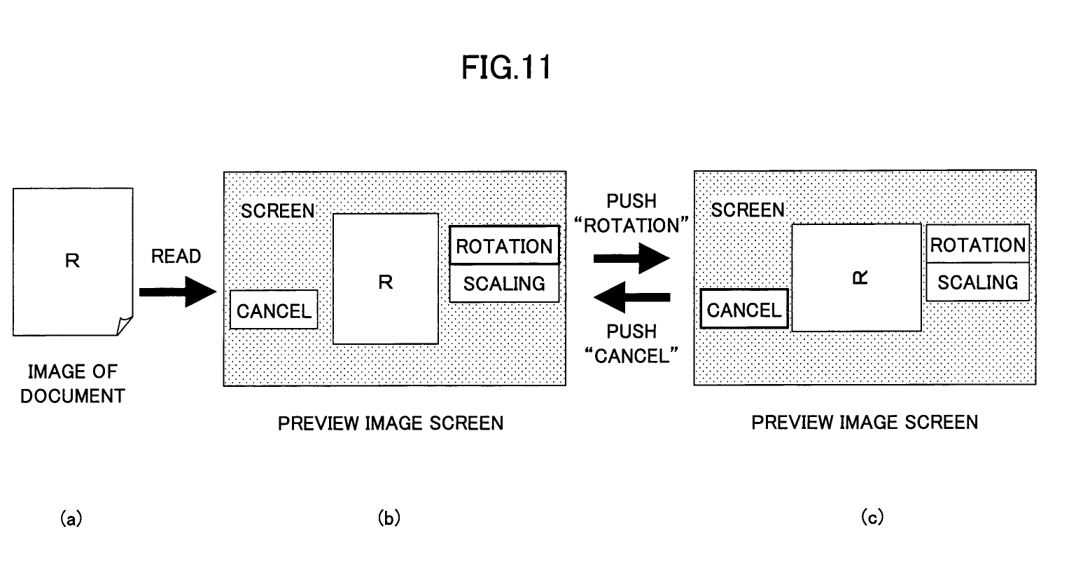

FIG. 11 is a diagram showing preview images displayed on the operating section device 56 based on the information from the preview image UI 326a shown in FIG. 10.

In FIG. 11, (a) shows an image of a document to be read, (b) shows a preview image screen where an original preview image is shown, and (c) shows a preview image screen where the original preview image is rotated.

As shown in FIG. 11(b), the preview image screen shows buttons of “CANCEL”, “ROTATION”, and “SCALING”, in addition to showing the original preview image. When the button “ROTATION” is pushed on the preview image screen shown in FIG. 11(b), the original preview image is rotated. When the button “SCALING” is pushed on the preview image screen shown in FIG. 11(b), the original preview image is enlarged or reduced.

As described above, in FIG. 11(c), the original preview image is rotated. However, when the button “CANCEL” is pushed on the preview image screen shown In FIG. 11(c), the preview image screen is returned to that shown in FIG. 11(b).

In the preview image screens shown FIGS. 11(b) and (c), the preview image of only the first page of the document is shown. However, as the preview image, plural pages of the document can be shown.

As described above, the preview image can be changed by the preview image UI 326a.

[Operations for Controlling Processing Order of Filters]

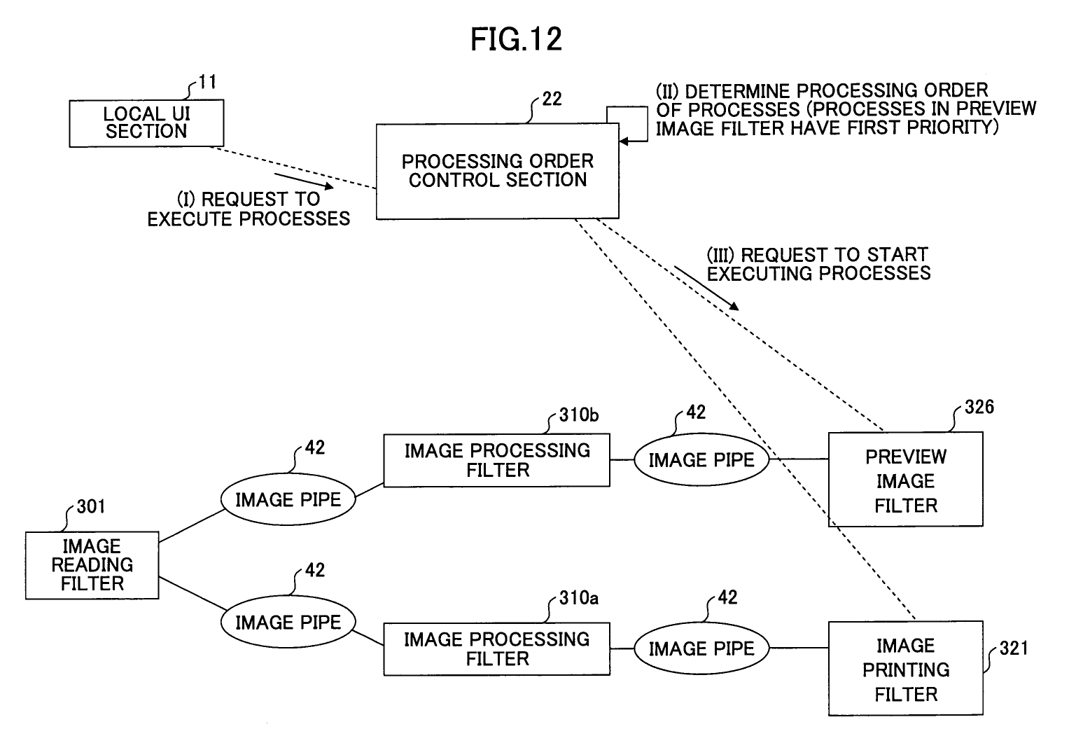

FIG. 12 is a diagram showing operations for controlling the processing order of filters by the processing order control section 22. In FIG. 12, the processing order control section 22 controls the processing order of the filters based on a request input from the local UI section 11. In FIG. 12, the local UI section 11 requests the processing order control section 22 to execute, for example, processes in image printing (I). The processing order control section 22 determines the processing order of the processes in the filters based on the priority order of the filters (II). In FIG. 12, since the priority order of the processes in the preview image filter 326 is higher than that in the other filters, the processes by the preview image filter 326 are executed with priority over the processes by the other filters.

When the processing order control section 22 determines the processing order of the processes in the filters, the processing order control section 22 requests the filters to start executing the corresponding processes based on the determined processing order (III).

The priority order of the processes in the filters can be stored in the priority order storing section 411 of the data managing section 41. Further, the priority order of the processes in the filters can be input to the priority order storing section 411 of the data managing section 41 from the processing order input section 111 of the local UI section 11.

[Displaying Preview Image based on Control of Processing Order of Filters]

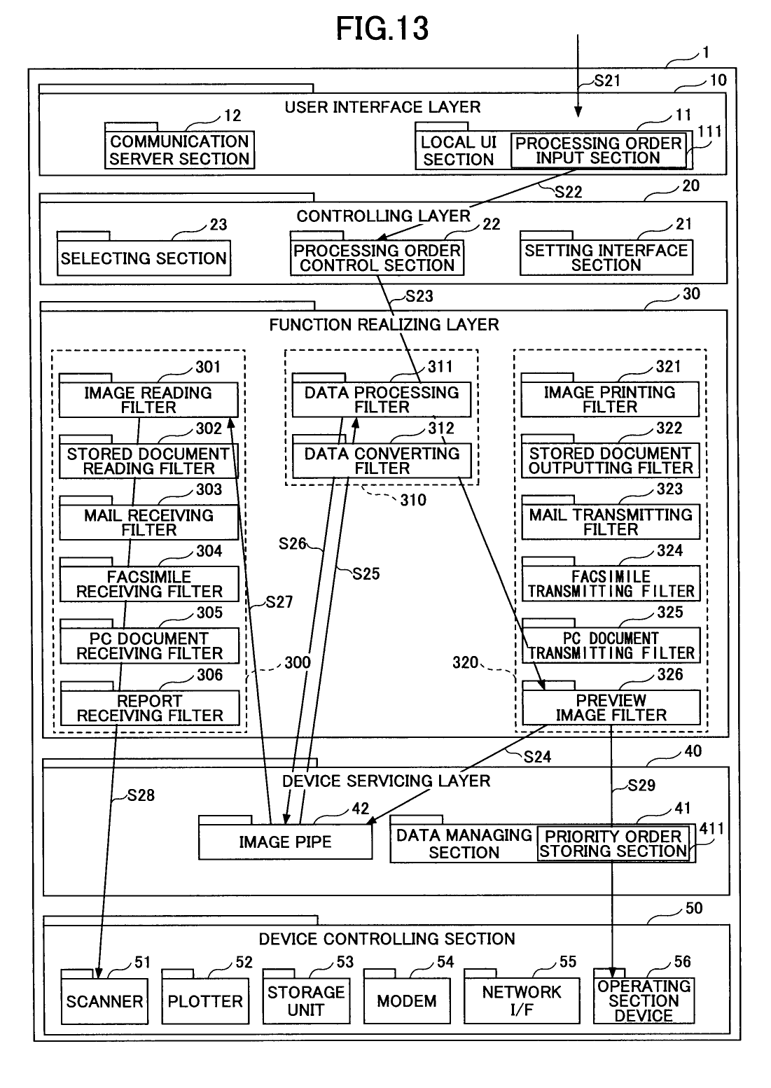

FIG. 13 is a diagram showing processes of displaying a preview image based on control of the processing order of filters.

In FIG. 13, first, the local UI section 11 receives a request for executing a printing process of an image and a displaying process of a preview image input from the operating section device 56 by a user (S21). In the printing process of the image and the displaying process of the preview image, after reading an image to be printed, a preview image of the read image is displayed and the read image is printed after the user confirms the preview image.

The local UI section 11 outputs the received request for executing the printing process of the image and the displaying process of the preview image to the processing order control section 22 of the controlling layer 20 (S22). The processing order control section 22 outputs a request to start a process for forming a preview image and displaying the preview image to the preview image filter 326 (S23). That is, the processing order control section 22 outputs a preview image displaying job to the preview image filter 326.

In processes from S23 through S28, based on the preview image displaying job shown in FIG. 4(b), each filter requests a corresponding filter to execute a process via a corresponding image pipe.

The preview image filter 326 outputs a request for obtaining an image from which a preview image is formed to the image pipe 42 (S24). The image pipe 42 outputs the request to the data processing filter 311 in the image processing filter 310 (S25).

The data processing filter 311 sends the requests to the image pipe 42 for obtaining the image from which the preview image is formed (S26). The image pipe 42 outputs a request for obtaining the image from which the preview image is formed to the image reading filter 301 (S27).

The image reading filter 301 requests the scanner 51 to read the image from which the preview image is formed (S28).

The scanner 51 reads the image from which the preview image is formed. The read image is output to the image reading filter 301 and the image reading filter 301 sends the read image to the preview image filter 326 via the data processing filter 311 (the image processing filter 310b) corresponding to the preview image displaying job shown in FIG. 4(b).

The preview image filter 326 forms a preview image based on the obtained image and requests the operating section device 56 to display the preview image (S29).

[Operations based on Completion of Displaying Preview Image]

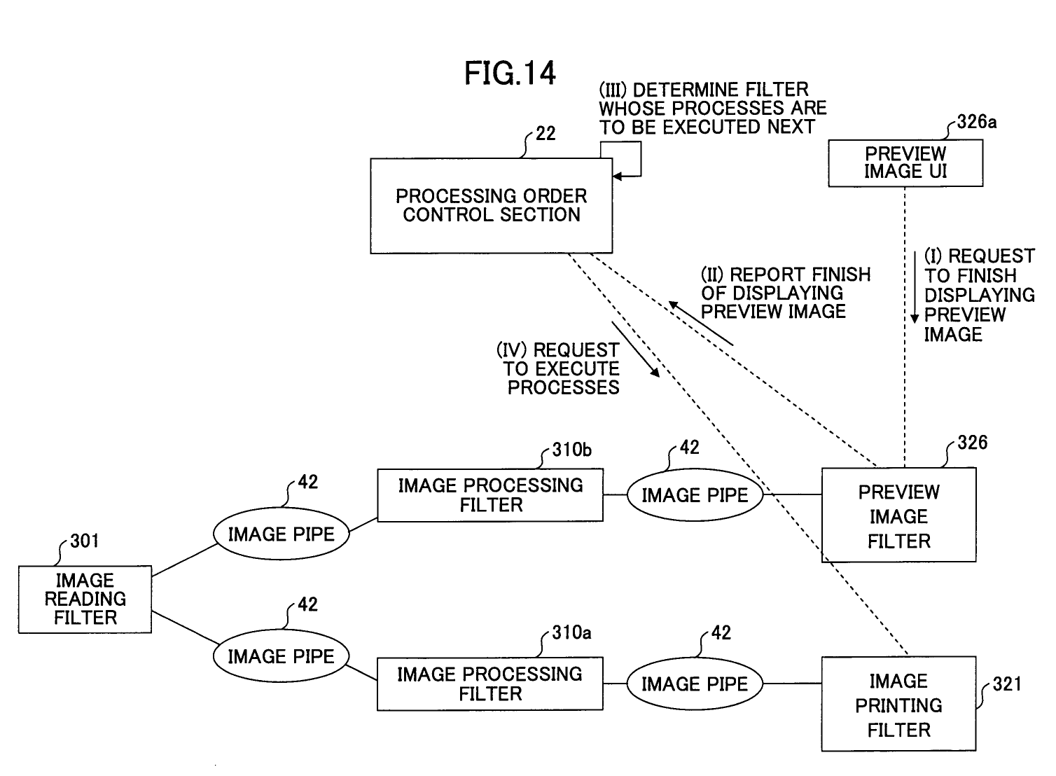

FIG. 14 is a diagram showing operations where the processing order control section 22 makes the image printing filter 321 print an image on a recording medium based on the completion of displaying the preview image. In FIG. 14, the processing order control section 22 makes the image printing filter 321 print an image based on the completion of displaying the preview image input from the preview image UI 326a.

In FIG. 14, the preview image UI 326a outputs a request to finish displaying the preview image to the preview image filter 326 (I). The preview image filter 326 reports that the displaying the preview image is finished to the processing order control section 22 (II).

The processing order control section 22 determines a filter whose processes are to be executed next based on the report that displaying the preview image is finished and requests the next filter to execute the processes (III). In this case, the processing order control section 22 requests the image printing filter 321 to execute processes for printing an image (IV).

The processing order of processes in the filters, which is determined by the processing order control section 22, can be determined by the priority order for executing the processes in the filters stored in the priority order storing section 411 in the data managing section 41, instead of by the processing order control section 22. The priority order for executing the processes in the filters can be input to the priority order storing section 411 from the processing order input section 111 of the local UI section 11.

In addition, in the processing order control section 22, the processing order can be determined by the order of the processes shown in jobs of FIG. 4.

[Flow of Processes for Displaying Preview Image based on Control of Processing Order of Processes in Filters]

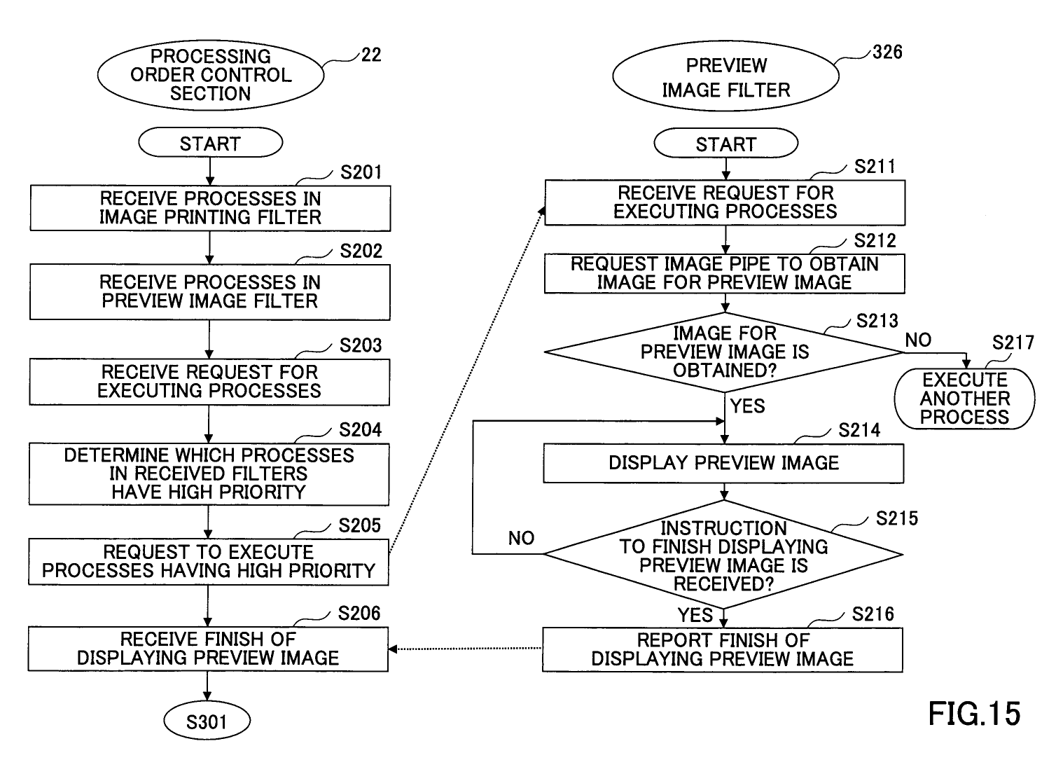

FIG. 15 is a flowchart showing processes in the processing order control section 22 and the preview image filter 326 based on control of the processing order of processes in filters. In FIG. 15, the processing order control section 22 controls the processing order of the processes in the filters based on a request input from the local UI section 11. In this case, the preview image filter 326 displays a preview image of an image to be printed based on the control of the processing order control section 22.

In FIG. 15, first, the processing order control section 22 receives processes in the image printing filter 321 in the printing job shown in FIG. 4(a) (S201). The processes in the image printing filter 321 can be input to the processing order control section 22 by the user from the operating section device 56.

Next, the processing order control section 22 receives processes in the preview image filter 326 in the preview image displaying job shown in FIG. 4(b) (S202). The processes in the preview image filter 326 can be input to the processing order control section 22 by the user from the operating section device 56.

The processing order control section 22 receives a request for executing the processes input from the local UI section 11 (S203). The processing order control section 22 determines which processes in the filters received in S201 and S202 have high priority (S204). The priority can be also determined by the priority order stored in the priority order storing section 411 of the data managing section 41.

As described above, since the preview image filter 326 has high priority, the processing order control section 22 requests the preview image filter 326 to execute the processes (S205). Based on the request, the preview image filter 326 executes processes from S211 through S216 (described below). When the preview image filter 326 finishes the processes, the processing order control section 22 receives the report of completion of the processes in the preview image filter 326 (S206).

When the processing order control section 22 receives the report of completion, the process goes to S301 (described below).

By the process in S205, the preview image filter 326 receives a request for executing the processes in the preview image filter 326 (S211). The preview image filter 326 requests the image pipe 42 to obtain an image for a preview image (S212). The process in S212 is the same as the process in S24 shown in FIG. 13.

The preview image filter 326 determines whether the image for the preview image is obtained via the image pipe 42 (S213). When the image for the preview image is not obtained via the image pipe 42 (NO in S213), another process is executed (S217). The process in S217 is, for example, to display an error message due to non-presence of the image for the preview image. The process in S213 can be executed plural times during a predetermined period.

When the image for the preview image is obtained via the image pipe 42 (YES in S213), the preview image filter 326 forms a preview image of the obtained image and displays the preview image on the operating section device 56 (S214).

The preview image filter 326 determines whether an instruction to finish displaying the preview image is received (S215). The instruction to finish displaying the preview image can be input from the user on the operating section device 56 or can be obtained when the user inputs an instruction for printing the image on the operating section device 56. When an instruction to finish displaying the preview image is not received (NO in S215), the process returns to S214 and the preview image is being displayed.

When an instruction to finish displaying the preview image is received (YES in S215), the preview image filter 326 reports the completion of displaying the preview image to the processing order control section 22 (S216).

[Printing Image based on Control of processing Order of Filters]

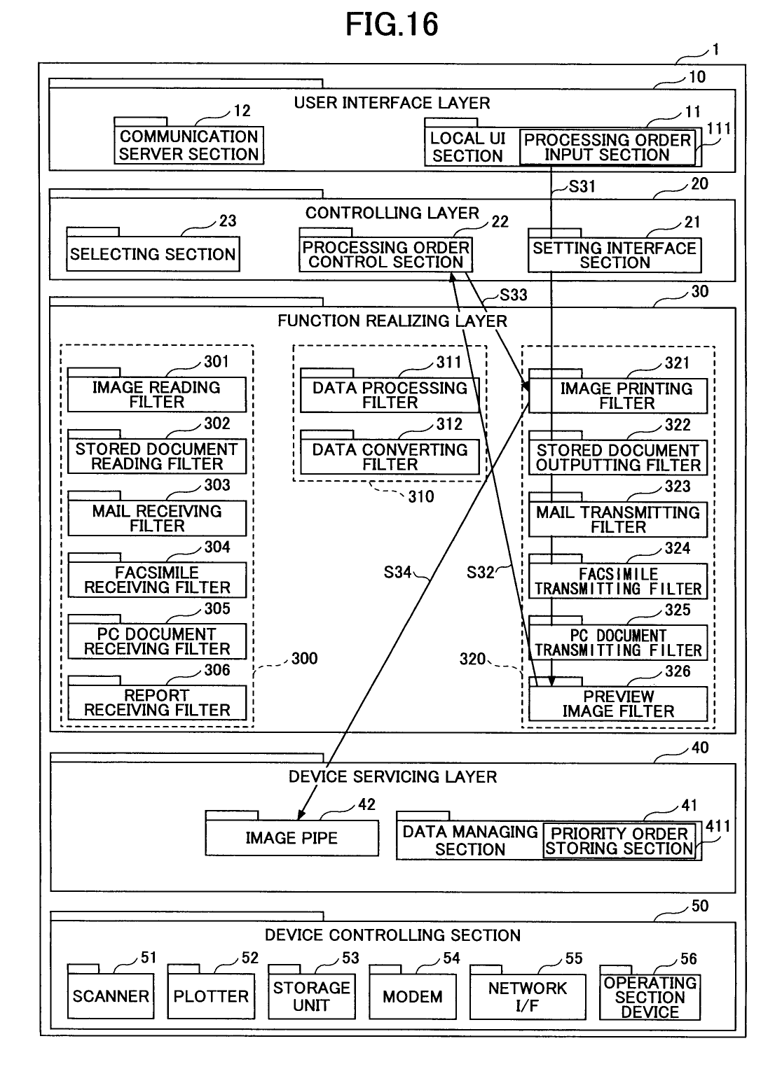

FIG. 16 is a diagram showing processes of printing an image based on control of the processing order of filters.

In FIG. 16, first, the local UI section 11 requests the preview image filter 326 to finish displaying the preview image (S31). The preview image filter 326 finishes displaying the preview image and reports the completion of displaying the preview image to the processing order control section 22 (S32).

The processing order control section 22 determines processes in a filter to be executed next. In this case, since processes in a filter to be executed next are the processes in the image printing filter 321, the processing order control section 22 requests the image printing filter 321 to start executing the processes (S33).

The image printing filter 321 requests the image pipe 42 to obtain an image to be printed (S34). The image pipe 42 obtains the image to be printed from the image reading filter 301 and sends the obtained image to the image printing filter 321. The image printing filter 321 prints the image on a recording medium. That is, an image input to the image reading filter 301 is printed on a recording medium by the image printing filter 321.

[Flow of Processes for Printing Image based on Control of Processing Order of Processes in Filters]

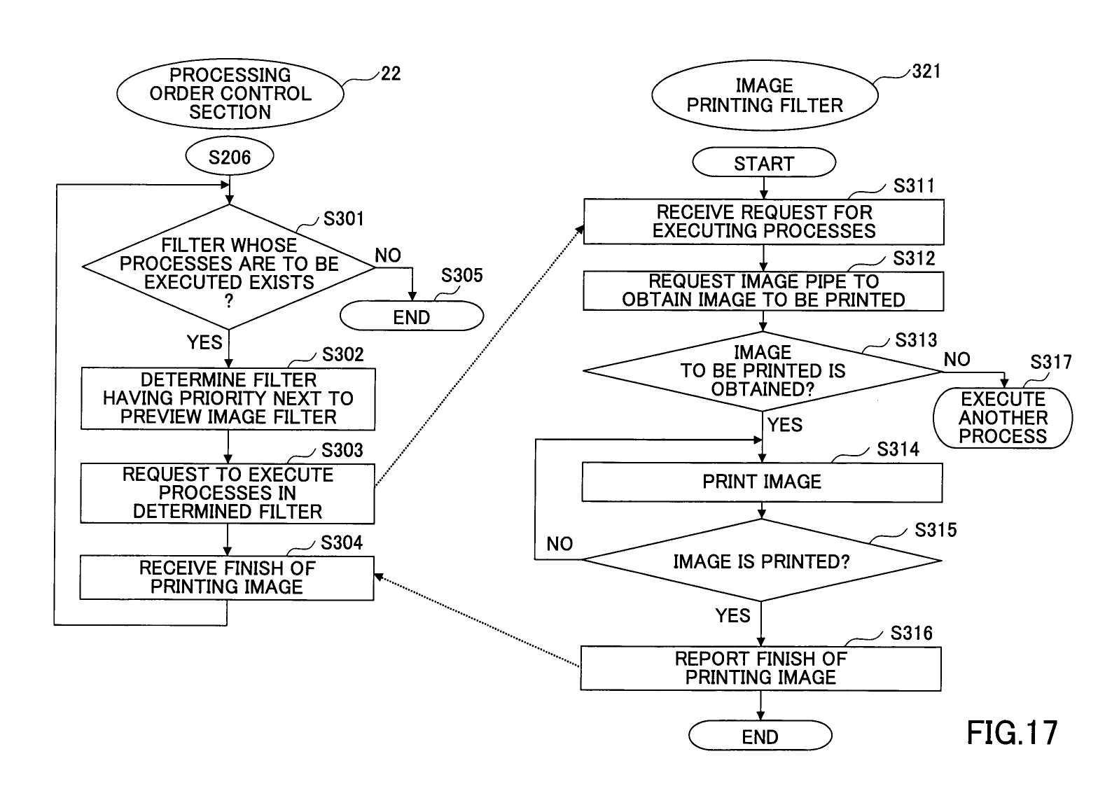

FIG. 17 is a flowchart showing processes in the processing order control section 22 and the image printing filter 321 based on control of the processing order of processes in filters. The processes shown in FIG. 17 are executed after executing the processes shown in FIG. 15.

In FIG. 17, first, the processing order control section 22 determines whether a filter whose processes are to be executed exists (S301).

When a filter whose processes are to be executed does not exist (NO in S301), the process ends (S305). When a filter whose processes are to be executed exists (YES in S301), the processing order control section 22 determines a filter having priority next to the preview image filter 326 whose processes have been finished (S302). Next, the processing order control section 22 requests the image printing filter 321 to execute processes (S303). Based on the request, the image printing filter 321 executes processes from S311 through S316 (described below).

The processing order control section 22 receives the report of completion of the processes in the image printing filter 321 (S304). After the process in S304, the process returns to S301, and the processes from S301 through S304 are repeated.

The image printing filter 321 receives the request for executing the processes in the image printing filter 321 from the processing order control section 22 (S311).

The image printing filter 321 requests the image pipe 42 to obtain an image to be printed (S312). The process in S312 is the same as the process in S34 shown in FIG. 16.

The image printing filter 321 determines whether the image to be printed is obtained via the image pipe 42 (S313). When the image to be printer is not obtained via the image pipe 42 (NO in S313), another process is executed (S317). The process in S317 is, for example, to display an error message due to non-presence of the image to be printed. The process in S313 can be executed plural times during a predetermined period.

When the image to be printed is obtained via the image pipe 42 and the obtained image is sent to the image printing filter 321 (YES in S313), the image printing filter 321 outputs data of the image to be printed to the plotter 52 and the plotter 52 prints the image on a recording medium (S314).

The image printing filter 321 determines whether the image is printed on a recording medium (S315). When the image is not printed on a recording medium (NO in S315), the process returns to S314 and the image is printed. When the image is printed on a recording medium (YES in S315), the image printing filter 321 reports the completion of the processes in the image printing filter 321 to the processing order control section 22 (S316).

### Modified Example of Embodiment

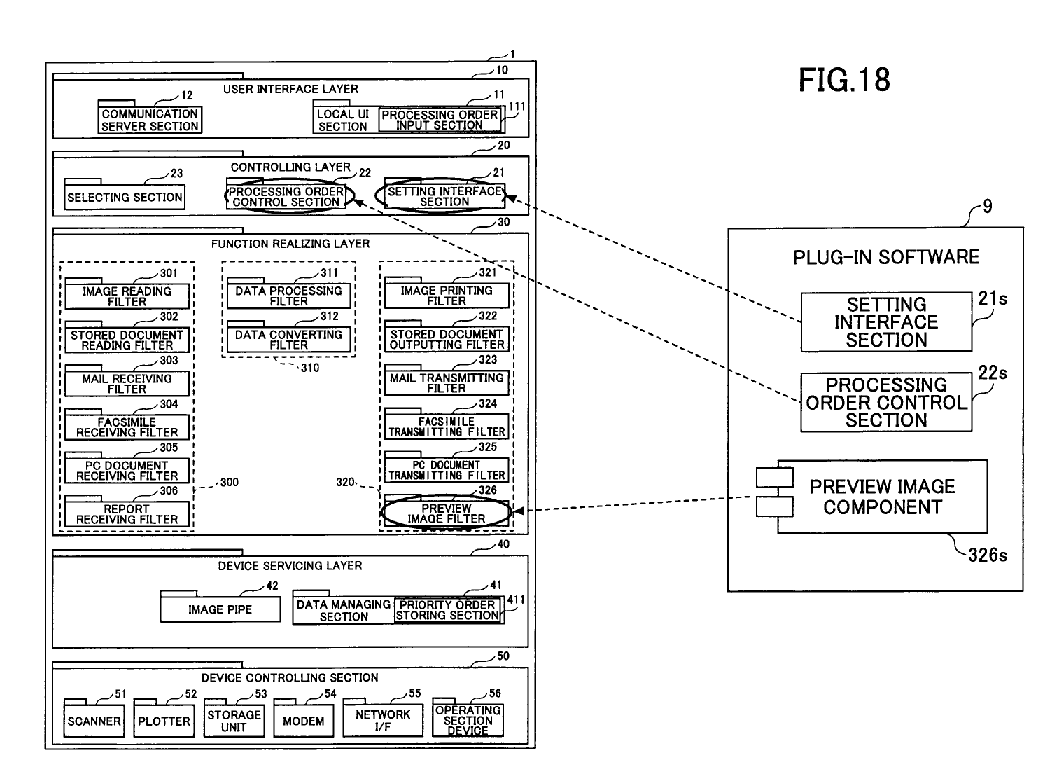

In a modified example of the present embodiment, functions for displaying a preview image are formed of plug-in software. FIG. 18 is a diagram showing the modified example of the image processing apparatus according the embodiment of the present invention. As shown in FIG. 18, the image processing apparatus 1 (MFP 1) includes plug-in software 9. The plug-in software 9 includes a setting interface section 21s, a processing order control section 22s, and a preview image component 326s. When the plug-in software 9 is installed in the MFP 1, the setting interface section 21s operates as the setting interface section 21, the processing order control section 22s operates as the processing order control section 22, and the preview image component 326s operates as the preview image filter 326.

[Structure of Computer]

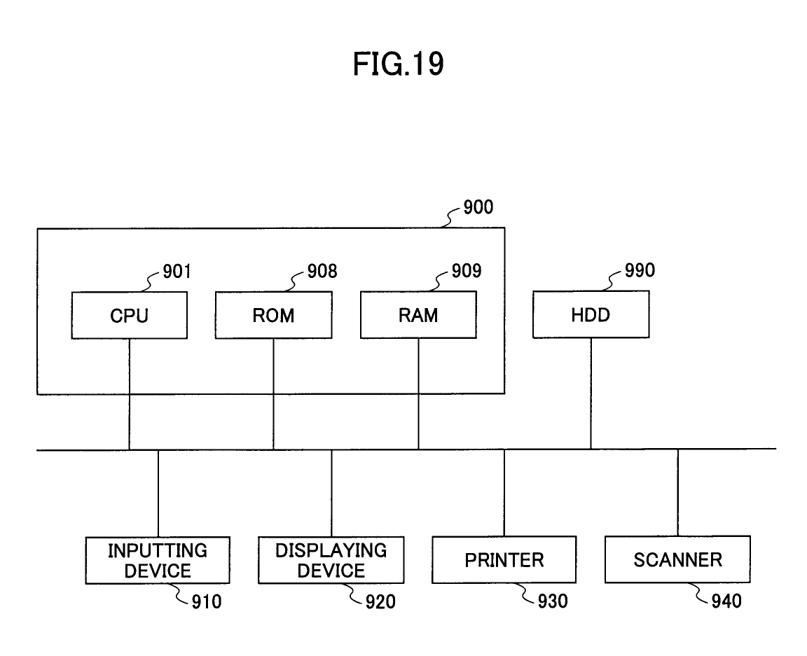

FIG. 19 is a diagram showing a structure of a computer by which the functions of the image processing apparatus of the present embodiment are realized. The computer shown in FIG. 19 includes a main processing unit 900, an inputting device 910, a displaying device 920, a printer 930, a scanner 940, and an HDD 990. The main processing unit 900 performs main functions of the computer and includes a CPU 901, a ROM 908, and a RAM 909. The CPU 901 reads a computer program from the ROM 908, stores the computer program in the RAM 909, and executes the computer program. The ROM 908 is formed of a non-volatile memory, and stores, for example, the computer program and parameters which are necessary to control the image processing apparatus. The RAM 909 operates as a working memory when the CPU 901 executes processes in the image processing apparatus.

The inputting device 910 is, for example, a keyboard from which a user inputs an instruction to the computer. The displaying device 920 displays, for example, operating conditions of the computer. The printer 930 prints an image on a recording medium. The scanner 940 optically reads an image formed on a recording medium. The HDD 990 stores a large amount of image data and computer programs.

The computer programs can be stored in a recording medium attachable to a driving device (not shown) of the recording medium in addition to being stored in the ROM 908 or the HDD 990.

In the embodiment of the present invention, as an example, displaying a preview image of an image to be printed is described. However, as described above, by using necessary filters and sections in the MFP 1, a preview image of a stored document to be output, a preview image of e-mail to be transmitted, a preview image of a facsimile to be transmitted, and a preview image of a PC document to be transmitted can be displayed.

In addition, in the embodiment of the present invention, the image inputting filter 300 includes the plural filters 301 through 306 and the image outputting filter 320 includes the plural filters 321 through 326. When a user desires to execute an additional job and desires to display a preview image of the additional job, the user can easily install an additional image inputting filter (if necessary) and an additional image outputting filter. Further, when the user desires not to execute an existing job, the user can easily uninstall an existing image inputting filter (if necessary) and an existing image outputting filter except for the preview image filter 326.

Further, the present invention is not limited to the specifically disclosed embodiment, and variations and modifications may be made without departing from the scope of the present invention.

The present invention is based on Japanese Priority Patent Application No. 2006-339910, filed on Dec. 18, 2006, with the Japanese Patent Office, the entire contents of which are hereby incorporated herein by reference.

What is claimed is:

1. An image processing apparatus, comprising:
a plurality of image outputting filters disposed corresponding to a plurality of image outputting devices;
a preview image filter which forms a preview image of an image to be output from each of the plural image outputting filters; and
a setting interface section which interfaces settings for outputting the preview image to be output from the preview image filter with settings for outputting the image to be output from each of the plural image outputting filters; wherein
one or more additional of the image outputting filters are capable of being installed in the image processing apparatus and one or more existing of the image outputting filters are capable of being uninstalled from the image processing apparatus.

2. The image processing apparatus as claimed in claim 1, wherein:
when the settings for outputting the image to be output from one of the plural image outputting filters are executed;
the one of the plural image outputting filters outputs information of the settings for outputting the image to the setting interface section; and
the setting interface section outputs the information of the settings for outputting the image to the preview image filter.

3. The image processing apparatus as claimed in claim 1, further comprising:
a preview image user interface disposed corresponding to the preview image filter; wherein
when information of the settings for outputting the preview image is input to the preview image filter from the preview image user interface;
the preview image filter outputs the information to the setting interface section; and
the setting interface section outputs the information to the corresponding one of the image outputting filters.

4. The image processing apparatus as claimed in claim 1, further comprising:
a selecting section which selects one of the plural image outputting filters corresponding to the plural image outputting devices; wherein
the setting interface section outputs information of the settings for outputting the image to be output to the selected one of the plural image outputting filters.

5. The image processing apparatus as claimed in claim 1, wherein:
one of the plural image outputting devices is a plotter, a storage unit, a facsimile machine, an e-mail transmitting device, or a network communication device.

6. The image processing apparatus as claimed in claim 1, further comprising:
a processing order control section for controlling a processing order of processes in the plural image outputting filters; wherein
the processing order control section controls executing processes in the image outputting filter corresponding to the preview image in the plural image outputting filters after receiving a report of completion of outputting the preview image from the preview image filter.

7. The image processing apparatus as claimed in claim 6, further comprising:
a processing order input section from which a user inputs the processing order of the processes in the plural image outputting filters to the processing order control section.

8. The image processing apparatus as claimed in claim 6, further comprising:
a priority order storing section which stores a priority order for executing the processes in the plural image outputting filters; wherein
the processing order control section controls executing the processes in the plural image outputting filters based on the priority order stored in the priority order storing section.

9. The image processing apparatus as claimed in claim 1, further comprising:
a displaying section which displays the preview image formed by the preview image filter and the image output from the image outputting filter corresponding to the preview image.

10. An image processing method in an image processing apparatus, comprising the steps of:
disposing a plurality of image outputting filters corresponding to a plurality of image outputting devices;
forming a preview image of an image to be output from each of the plural image outputting filters by a preview image filter; and
interfacing settings for outputting the preview image to be output from the preview image filter with settings for outputting the image to be output from each of the plural image outputting filters by a setting interface section; wherein
one or more additional of the image outputting filters are capable of being installed in the image processing apparatus and one or more existing of the image outputting filters are capable of being uninstalled from the image processing apparatus.

11. The image processing method as claimed in claim 10, further comprising the steps of:
when the settings for outputting the image to be output from one of the plural image outputting filters are executed;
outputting information of the settings for outputting the image to the setting interface section from the one of the plural image outputting filters; and
outputting the information of the settings for outputting the image to the preview image filter from the setting interface section.

12. The image processing method as claimed in claim 10, further comprising the steps of:
disposing a preview image user interface corresponding to the preview image filter;
when information of the settings for outputting the preview image is input to the preview image filter from the preview image user interface,
outputting the information to the setting interface section from the preview image filter; and
outputting the information to the corresponding one of the image outputting filters from the setting interface section.

13. The image processing method as claimed in claim 10, further comprising the steps of:
selecting one of the plural image outputting filters corresponding to the plural image outputting devices; and
outputting information of the settings for outputting the image to be output to the selected one of the plural image outputting filters.

14. The image processing method as claimed in claim 10, wherein:
one of the plural image outputting devices is a plotter, a storage unit, a facsimile machine, an e-mail transmitting device, or a network communication device.

15. The image processing method as claimed in claim 10, further comprising the steps of:
controlling a processing order of processes in the plural image outputting filters; and
controlling executing processes in the image outputting filter corresponding to the preview image in the plural image outputting filters after receiving a report of completion of outputting the preview image from the preview image filter.

16. The image processing method as claimed in claim 15, further comprising the step of:
inputting the processing order of the processes in the plural image outputting filters by a user.

17. The image processing method as claimed in claim 15, further comprising the steps of:
storing a priority order for executing the processes in the plural image outputting filters; and
controlling executing the processes in the plural image outputting filters based on the stored priority order.

18. The image processing method as claimed in claim 10, further comprising the step of:
displaying the preview image formed by the preview image filter and the image output from the image outputting filter corresponding to the preview image.
